(19) United States
(12) Patent Application Publication
(10) Pub. No.: US 2014/0108068 A1
(43) Pub. Date: Apr. 17, 2014

(54) System and Method for Scheduling Tee Time

(71) Applicant: Jonathan A. Williams, Naperville, IL (US)

(72) Inventor: Jonathan A. Williams, Naperville, IL (US)

(21) Appl. No.: 14/056,708

(22) Filed: Oct. 17, 2013

Related U.S. Application Data
(60) Provisional application No. 61/715,102, filed on Oct. 17, 2012.

(51) Int. Cl. G06Q 10/02

(52) U.S. Cl. CPC G06Q 10/02
USPC 705/5

(57) ABSTRACT

A tee time scheduling system includes a computing server including a processor and memory. The computing server receives information from one or more computing servers, each of which is associated with a golf course, regarding a current and future tee time status, and receives a query from a computing device regarding tee time openings occurring on a select day and in a particular geographical area. The computing server further determines tee time availability and associated golf courses located the particular geographical area based on a comparison between the current and future tee time status and the select day, generates a geographical map having location indicators of the associated golf courses, and forwards to the computing device for display on a display screen of the computing device the geographical map.

### CROSS-REFERENCE TO RELATED APPLICATIONS

The present application claims priority under 35 U.S.C. §119(e) to U.S. Provisional Patent Application Ser. No. 61/715,102 filed Oct. 17, 2012, which is incorporated herein by reference in its entirety.

### BACKGROUND

Unless otherwise indicated herein, the materials described in this section are not prior art to the claims in this application and are not admitted to be prior art by inclusion in this section.

The golf industry suffers from a communication and information gap between the golf course and the golfer for available tee times. Recent slack in tee time demand has course operators looking toward and dependent on cooperation and synergies from vertical and horizontal chain partners in order to survive. In the late 1990s, the golf industry saw a spike in overall growth, participation, and popularity. The communication gap between the golf course and the golfer existed at the peak of the business cycle in the 1990s and this gap continues today. The difference today is that golf is in a trough in the business cycle resulting in course closures and contraction in participation.

In 2011, there were 157 public golf course closings compared to 19 new public course openings. The economic stress of few rounds and lower revenue year after year continues to hit golf course owners and operators. While golf remains an integral recreation sport as well as a key business networking tool, rounds continue to fall faster than total golfers leaving the game. Golfers are playing fewer rounds but are not giving up the game totally.

Despite this clear need, there is currently no easy way for golfers to find the desired tee time without laboriously searching websites or making multiple phone calls. Therefore, the golf industry and golfers are in need of more efficient tee time reservations.

### SUMMARY

Disclosed herein is a system and method for scheduling tee time.

In one aspect, an embodiment of a tee time scheduling system includes a computing server including a processor and memory. The computing server receives information from one or more computing servers, each of which is associated with a golf course, regarding a current and future tee time status, and receives a query from a computing device regarding tee time openings occurring on a select day and in a particular geographical area. The computing server further determines tee time availability and associated golf courses located the particular geographical area based on a comparison between the current and future tee time status and the select day, generates a geographical map having location indicators of the associated golf courses, and forwards to the computing device for display on a display screen of the computing device the geographical map.

In another aspect, a non-transitory computer-readable storage medium includes programming instructions that are executable by a computing system to receive information from one or more computing servers, each of which is associated with a golf course, regarding a current and future tee time status of each one of the golf courses, receive a query from a computing device regarding tee time openings occurring on a select day and in a particular geographical area, determine tee time availability and associated golf courses located in the particular geographical area based on a comparison between the current and future tee time status and the select day, generate a geographical map having overlaid thereon location indicators of the associated golf courses, and a golf course table that lists the associated golf courses and their respective tee time data, and forward to the computing device for display on a display screen of the computing device the geographical map and the golf course table.

In yet another aspect, a computer-implemented method for scheduling a tee time includes accessing a Web site of a tee time scheduling entity, receiving a user interface screen that includes a window for entering a desirable tee time, and a geographical location, receiving a geographical map with location indicators of golf courses overlaid thereon, wherein the golf courses were determined based on the entered tee time and the geographical location, selecting one of the location indicators, and receiving a pop-up window that includes a tee time table listing tee time data of a golf course associated with the selected location indicator.

These as well as other aspects, advantages, and alternatives will become apparent to those of ordinary skill in the art by reading the following detailed description, with reference where appropriate to the accompanying drawings. Further, it should be understood that the disclosure provided in this summary section and elsewhere in this document is intended to discuss the embodiments by way of example only and not by way of limitation.

### BRIEF DESCRIPTION OF THE FIGURES

These and other features, aspects, and advantages of the present disclosure will become better understood when the following detailed description is read with reference to the accompanying drawings in which like characters represent like parts throughout the drawings, wherein:

FIG. 1 is a system diagram illustrating an embodiment of a computer networked system in accordance with the present disclosure;

FIG. 2A illustrates exemplary embodiments of mobile computing devices that can be used for tee time scheduling;

FIG. 2B illustrates exemplary embodiments of personal computers that can be used for tee time scheduling;

FIG. 3 is a schematic block diagram illustrating interactive hardware and computer components of a computing device;

FIGS. 4A-B are schematic block diagrams illustrating components of memories of computing devices;

FIG. 5 is a block diagram illustrating components of a computing server associated with a tee time scheduling entity;

FIG. 6 is a flow chart illustrating a tee time scheduling process flow;

FIG. 7 is a flow chart illustrating a process for setting up a customer account;

FIG. 8 is flow chart illustrating an exemplary method for scheduling a tee time by accessing the Web site of the tee time scheduling entity;

FIG. 9 shows an exemplary user interface screen that includes a geographical map and a window for entering search parameters for a desirable tee time;

FIG. 10 shows another exemplary user interface screen that includes a golf course table in addition to the geographical map;

FIG. 11A shows another exemplary user interface screen that includes a plurality of location indicators of golf courses overlaid on a geographical map;

FIG. 11B shows another exemplary user interface screen where location indicators are aggregated;

FIG. 12 shows another exemplary user interface screen that includes Today, Tomorrow and Beyond toggles for selection by a user;

FIG. 13 shows another exemplary user interface screen that represents a one page confirmation of a tee time reservation;

FIG. 14 is a schematic diagram illustrating a conceptual partial view of an example computer program product.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### Overview

As stated above, the golf industry suffers from a communication gap between the golf course and the golfer for available tee times. Moreover, golfers want a fast, efficient method to find the right tee time, at the right golf course, and preferably at the right price. Currently, golfers have to scavenge through individual golf courses, by accessing their websites and/or by calling their reservation offices, to find available tee times and prices to pay. However, these golfers often give up their scavenging because of the lengthy time it often takes to find the tee times they want, or because they just can't find what they want. In addition, golf courses want to increase tee time sales and minimize discounting of tee times.

Accordingly, a method and system have been configured to show and provide golfers more opportunities as to where and when they can play golf, and enable them to make reservations for tee times that suit their schedules and their budgets. By providing an improved tee time search process for golfers, the proposed method and system enable the generation of more rounds of golf and increased revenues for partner golf courses, which provide information data about their tee time schedules and prices (green fees) through the system.

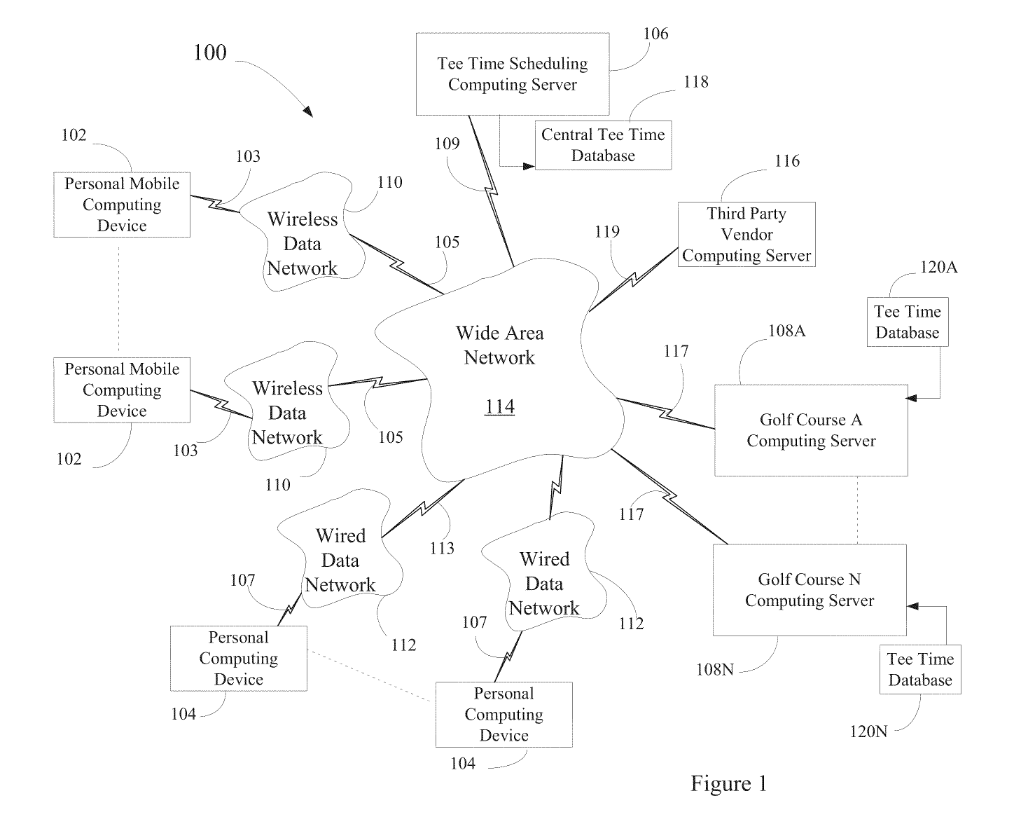

Referring to FIG. 1, a system diagram illustrates an embodiment of a computer networked system 100 for generating a tee time scheduling and reservation on a personal computer device. Computer networked system 100 includes a plurality of wireless personal computers 102, a plurality of personal computers 104, a tee time reservation/scheduling server computer 106, a plurality of golf course server computers 108, a plurality of wireless data networks 110, a plurality of wired data networks 112, a wide area network (WAN) 114, and a third party vendor computing server 116. Wide area network 114, wireless data networks 110 pertain to some portions of the World Wide Web (WWW, hereafter referred to as Web) and the Internet.

Each of wireless data networks 110 can include one or more wireless data networks, such as cellular networks, WiFi networks, Bluetooth networks, etc . . . Each of wired data networks 110 can include a local area network (LAN). Tee time scheduling server computer 106 can couple to network 114 over a wireless or wired communication link 109. Each of wireless personal computers 102 can couple via a wireless communication link 103 to one of wireless data networks 110, which in turn can couple to network 114 over one of wireless or wired links 105. In this regard, wireless personal computers 102 can access tee time scheduling server computer 106 through one of wireless data network 110 and network 114. Personal computers 104 can couple via a wired link 107 to one of wired data networks 112, which in turn can couple to network 114 over one of communication links 113. Golf course servers 108 can couple to wide area network 114 via a wireless or wired communication link 117. Third party vendor computing server 116 can couple to wide area network 114 via a wireless or wired communication link 119. As known to one of ordinary skills in the art, wireless communication links may use Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities.

As shown in FIG. 1, each of tee time scheduling server computer 106 and golf course servers 108A-108N is coupled to a database 118 or 120A-N, respectively. Alternatively, each of tee time scheduling server computer 106 and golf course servers 108A-108N may include an integral database (not shown).

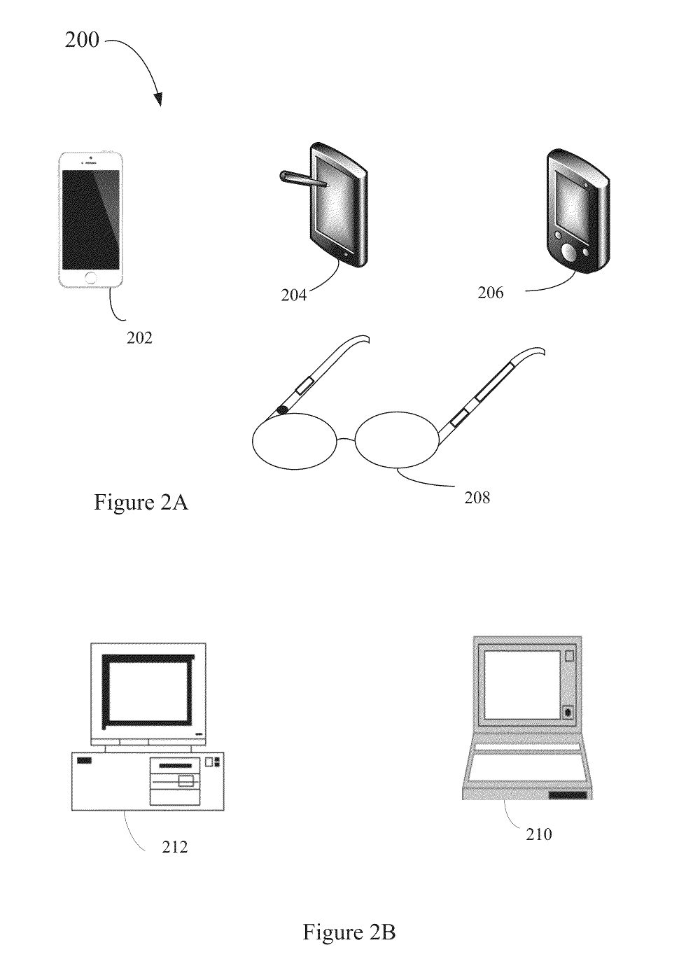

Now referring to FIG. 2A, wireless personal computers 102 may include portable (or mobile) computing devices, such as a wireless mobile/smart phone 202, a wireless tablet or notebook computing device 204, a personal data assistant (PDA) 206, or a hybrid device that includes functions of any of the above-cited computing devices. In one embodiment, a wireless personal computing device 102 may be a head wearable display device 208. Moreover, as shown in FIG. 2B, personal computers 104 may include wired PC devices, such as a lap top computer 210, and a desk top computer 212.

As known to one of ordinary skills in the art, each of wireless personal computers 102 and personal computers 104 includes a display device and an input device, such as a keyboard that enables the searcher to interface with a search engine and submit queries and obtain search results based on the submitted search queries. Further, each of wireless personal computers 102 may include a virtual keyboard that is displayed on the display device, such as display device.

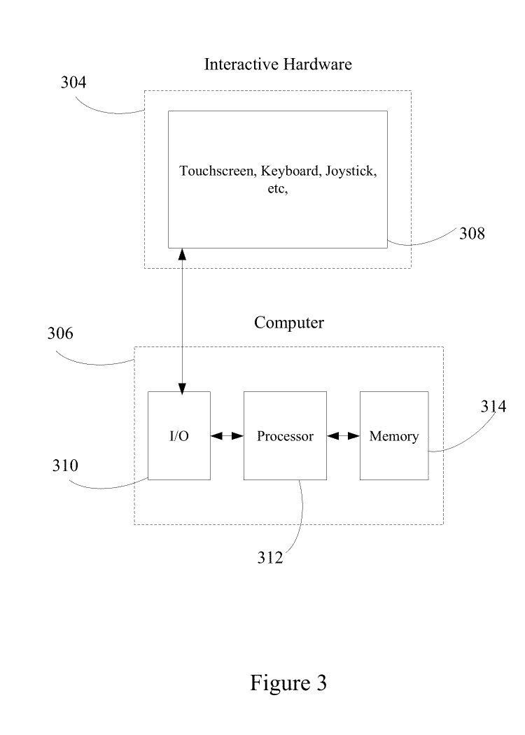

Now referring to FIG. 3, each of a wireless mobile personal computer 102 and a personal computer 104 includes an interactive hardware portion 304 and a computer portion 306. The interactive hardware portion 304 can include one or more of a touch screen, a keyboard, a stylus, a joystick, and the like 308, which can be arranged in various manners and have different shapes without changing the spirit of the interaction of the hardware portion 304 with the input/output (I/O) portion 310. The touch screen can a liquid display crystal (LCD), display screen, a plasma screen, a light emitting diode (LED), or any other screen capable of displaying text and images. The computer portion 306 includes an input/output (I/O) portion 310, a central processing unit (CPU) portion 312, i.e., a microprocessor, and a memory 314. CPU portion 312 can be any computer-processing unit from a singular microchip to extensive microchip configurations. Memory portion 314 can include, without limitation, any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory portion 314 may incorporate electronic, magnetic, optical, and/or other types of storage media, and can have a distributed architecture where various components are situated remote from one another, but are still accessed by microprocessor portion 312. The interactive hardware portion 304 is coupled to the I/O portion 310 such that a command entered by a user through the interactive hardware portion 304 will be forwarded to the I/O portion 310, to the processor portion 312 and then to memory portion 314.

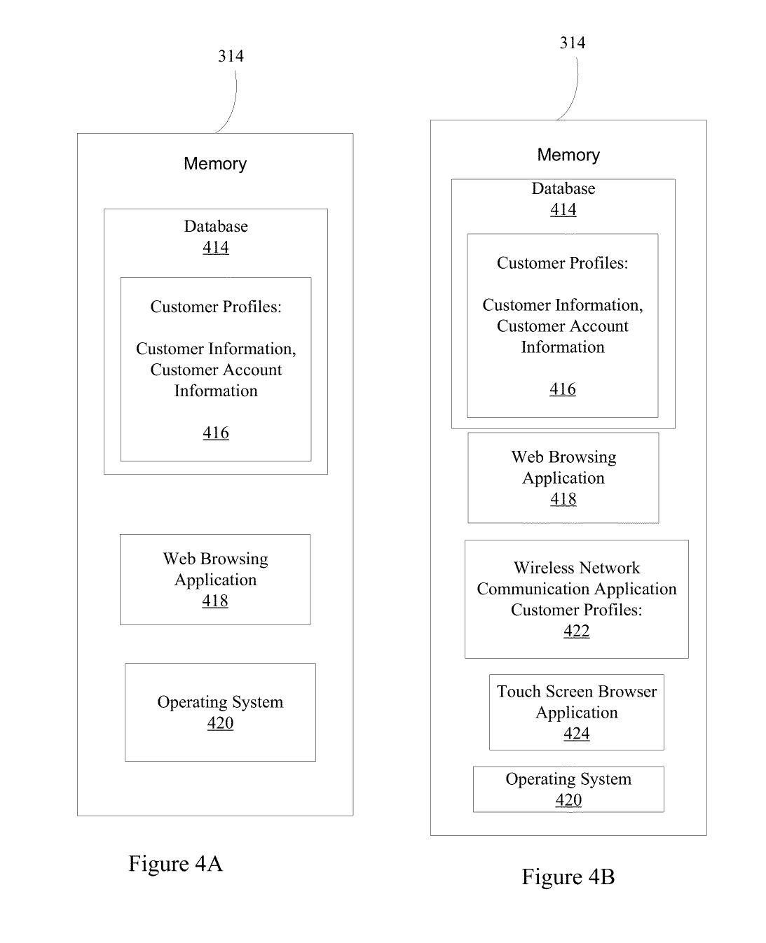

As illustrated in FIGS. 4A and 4B, schematic diagrams 400 of the memory portion 314 of FIG. 3 are shown. For a personal computing device 104, as shown in FIG. 4A, memory portion 314 can include or store a database 414, a Web browsing application 418, and an operating system 420. The database 414 can store data related to customer profiles 416, which can include customer information, customer account information, and favorite golf courses. For a wireless computing device 102, memory 314 further includes an executable wireless network communication software application 422, and an executable touch screen browser software application 424, for operating in connection with the microprocessor portion 312 or other hardware device. The executable applications (programs) 418, 420, and 424 can be implemented in software, firmware, hardware, or a combination thereof. Operating system 420 essentially controls the execution of computer programs, and provides scheduling, input-output control, file and data management, memory management, and communication control and related services. Operating systems are generally well known and will not be described in greater detail. The operating system can also be a special purpose operating system, such as may be used for limited purpose appliance-type computing devices.

When a wireless mobile personal computer 102 or a personal computer 104 is in operation, CPU portion 312 is configured to execute software stored within memory 314, to communicate data to and from memory 314, and to generally control operations of personal computers 102 and 104 pursuant to the software. The executable applications (programs) 416, 418, 420, and 424, and the operating system 420, in whole or in part, but typically the latter, are read by the CPU portion 312, perhaps buffered within the CPU portion 312, and then executed. When one of the executable applications is implemented in software, it can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The executable applications 418 can be embodied in any non-transitory computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

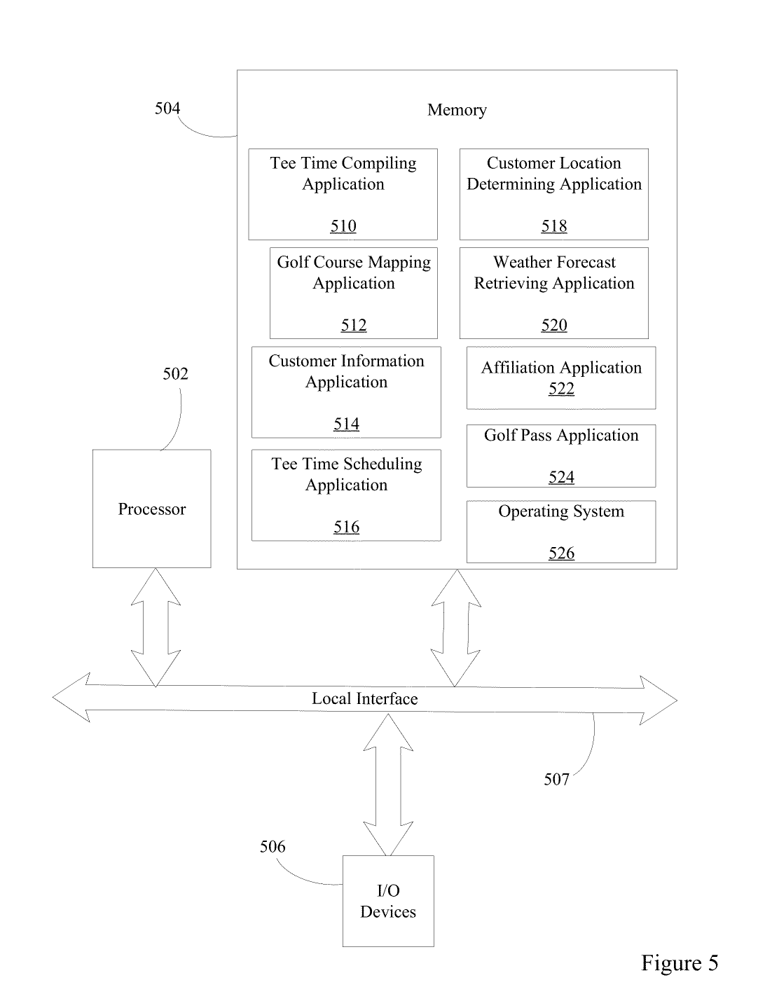

Now referring to FIG. 5, a block diagram illustrates a tee time scheduling server computing system 500. Generally, in terms of hardware architecture, tee time scheduling server computing system 500 includes a processor 502, a memory 504, one or more input and/or output (I/O) devices 506 (or peripherals) that are communicatively coupled via a local interface 507. Local interface 507 can be, for example, but not limited to, one or more buses or other wired or wireless connections, as is known in the art. Local interface 507 may have additional elements, which are omitted for simplicity, such as controllers, buffers (caches), drivers, repeaters, and receivers, to enable communications. Further, local interface 408 may include address, control, and/or data connections to enable appropriate communications among the other computing system components.

The processor 502 is a hardware device for executing software, particularly software stored in memory 504. The processor 502 can be any custom made or commercially available processor, a central processing unit (CPU), an auxiliary processor among several processors, a semiconductor based microprocessor (in the form of a microchip or chip set), a macro processor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. The processor 502 may also represent a distributed processing architecture such as, but not limited to, SQL, Smalltalk, APL, KLisp, Snobol, Developer 200, MUMPS/Magic.

As stated above regarding memory 314, memory 504 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 504 may incorporate electronic, magnetic, optical, and/or other types of storage media. Memory 504 can have a distributed architecture where various components are situated remote from one another, but are still accessed by the processor 502.

The software in memory 504 may include one or more separate applications (i.e., programs or modules). The separate applications include ordered listings of executable instructions for implementing tee time applications. In the example of FIG. 5, the software in memory 504 includes a tee time compiling application 510, a golf course mapping application 512, a user/customer (e.g., golfer) information application 514, a tee time scheduling processing application 516, a customer location determining application 518, a weather forecast retrieving application 520, an affiliation application 522, a gift card application 524, and a suitable operating system (O/S) 526. A non-exhaustive list of examples of suitable commercially available operating systems 526 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system 526 essentially controls the execution of computing applications associated with memory 504, and provides scheduling, input-output control, file and data management, memory management, and communication control and related services.

Each of the applications 510, 512, 514, 516, 518, 520, 522, 524, and 526 may be a source program, executable program (object code), script, or any other entity comprising a set of instructions to be performed. When a source program, the program needs to be translated via a compiler, assembler, interpreter, or the like, which may or may not be included within memory 504, so as to operate properly in connection with the O/S 522. Furthermore, each of applications 510, 512, 514, 516, 518, 520, 522, 524, and 526 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada. In one embodiment, when installed within memory 504 of tee time reservation server computing system 500, each of applications 510, 512, 514, 516, 518, 520, 522, 524, and 526 is written in C/C+/C++ format, and browser software may be used.

Each of the applications 510, 512, 514, 516, 518, 520, 522, 524, and 526 can be implemented in software, firmware, hardware, or a combination thereof. In one mode, each of these applications is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. Therefore, tee time scheduling server computing system 500 may be representative of any computer in which applications 510, 512, 514, 516, 518, 520, 522, 524, and 526 reside or partially reside.

The I/O devices 506 may include input devices, for example but not limited to, a keyboard, mouse, microphone, touch screens, interfaces for various devices, stylus, etc. Furthermore, the I/O devices 506 may also include output devices, including, but not limited to, a printer, displays such as touch screen displays, etc. Finally, the I/O devices 506 may further include devices that communicate both inputs and outputs, for instance but not limited to, a modulator/demodulator (modem; for accessing another device, system, or network), a radio frequency (RF) or other transceiver, a telephonic interface, a bridge, and a router.

In accordance with an exemplary embodiment of the present disclosure, in order to find out what tee times are available at golf courses located in a particular geographical area, a user can interact with an online tee time scheduling Web site by accessing a home Web page and entering search parameters in an user interface screen to search for desirable tee times, such as for a last-minute tee time search for example. In addition to desirable tee times, the search parameters can include an identification of the geographical area where the user wishes to play golf, and a number of golfers that are planning to play together as a party. Once the user has entered the search parameters, a geographical map will be generated for display on the user's device display screen to provide a visual value of where the golf courses, identified/determined based on the search parameters, are located. The locations of these golf courses are provided on the geographical map as overlay data, represented as location indicators that can be map flags or push pins for example.

These golf course location indicators are displayed/overlaid on the identified geographical area map based on available tee times, which were determined by comparing the entered tee times with the recently cached tee times, which are provided by computing servers associated with the found golf courses or by a third party entity, via an application programming interface (API), such as a vendor that handles making tee time reservations at golf courses. Data wise, in one exemplary embodiment, each of the displayed location indicators includes its corresponding available tee times.

After detecting a selection of a golf course by the user who may have clicked on the associated location indicator using a mouse, or may have hovered, touched, or gestured on the device touch screen near or at that location indicator position on the area map, the computing server 106 moves the process to the reservation stage by checking with the golf course server or the third party vendor server whether the determined available tee times are still available and whether their corresponding number of available player slots are still greater than or equal to the number of players entered by the user. If checking is positive, i.e. the same tee times and number of players are still available, then the computing server 106 generates and provides for display to the user, directly or via the vendor's API, a new user interface screen or add a window box to the current user interface screen that includes a reservation button or toggle for activation by the user. Upon completion of the reservation, computing server 106 generates a new user interface screen or an additional dialog window that includes a statement confirming the reservation. Alternatively, computing server 106 may communicate/send to the user a reservation confirmation via email or via text. In another embodiment, the reservation process may be performed directly with the computer server of the selected golf course, and a confirmation will also be sent to computer server 106, whose tee time database 118 will then be updated with a record of this reservation.

As stated above, after accessing the home page of the Web site maintained by the computing server 106, the user enters search parameters into a search criteria box or window. By entering a city's name, and its state's name if needed, the geographical map is adjusted accordingly. Alternatively, the user may enter a zip code that will also adjust the geographical map accordingly. Moreover, the selected number of golfers enables an adjustment of the display of tee times based on whether it exceeds the number of available golfer spots at each of those available tee times. As such, if the selected number of golfers exceeds the number of available golfer spots, then the corresponding golf course indicators can be either removed from the displayed geographical map or may have their respective colorings changed. To provide an accurate display of available tee times, the process is configured to display only available tee times that start at the same time or after that of the earliest entered tee time. For example, a search for available tee times that start a noon or later leads the process to not display any location indicators that are associated with only cashed available tee times that start before noon.

In one embodiment, in lieu of entering a zip code or a city's name, the user may enter a name of a specific golf course and a desirable tee time. As such, the displayed geographical map will include only one location indicator, which include appropriate available tee times at that specific golf course.

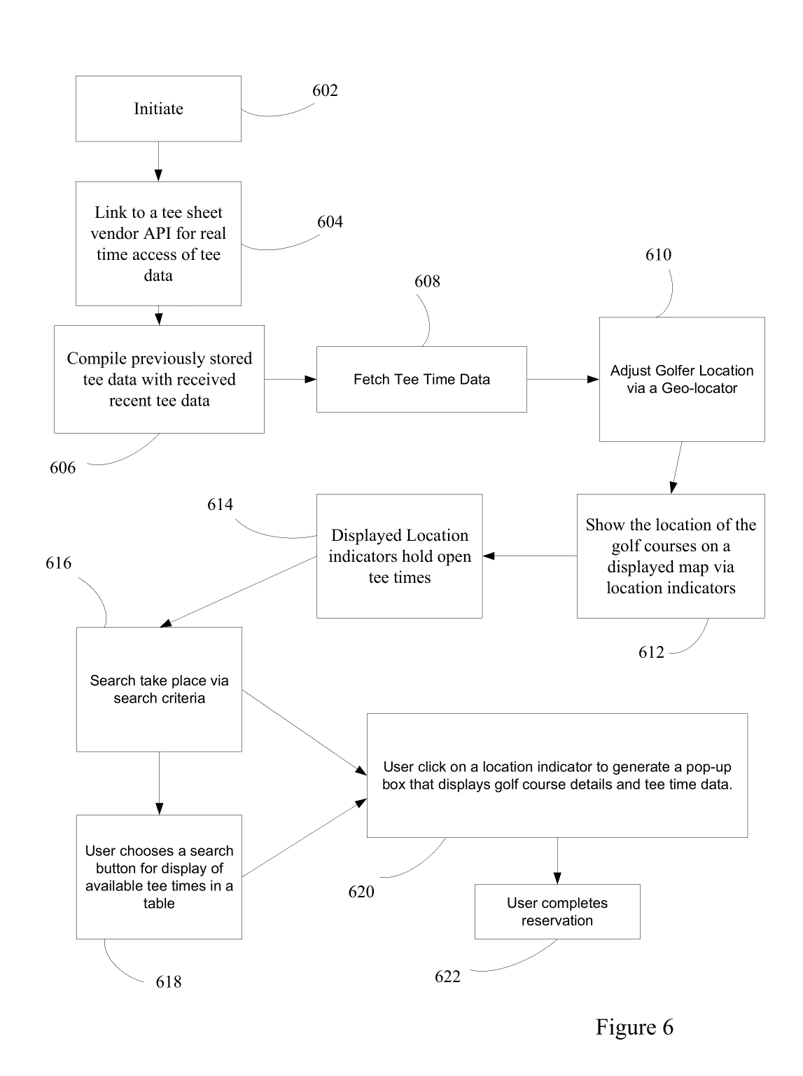

Now referring to FIG. 6, a flow chart shows an exemplary embodiment of a process flow (method) 600, initiated at Step 602, for fetching and compiling tee time schedules and green fees from databases of golf courses, and enabling a user to search online for available tee times suitable for his/her schedule and budget, and making a tee time reservation. At Step 604, in one embodiment, tee time computing server 106 is configured to link to a tee sheet vendor API for real time access of tee data recently stored or cached in databases of golf courses for storage in tee time database 118. Alternatively, tee time computing server 106 is configured to couple to the golf course databases without a third party API. In another embodiment, operators/managers at the golf courses may provide, via emails or faxes, tee sheets that include their respective golf course locations, available tee times, green fees, and number of golfers associated with those tee times, for manually entry or digital entry using a scanning and digital reading of the tee sheets. At Step 606, once recent tee data is received, the tee time compiling application is configured to compile previously stored tee data, if any, with the recently received tee data to establish an updated tee data, which will be the source of tee times searched by the user.

At Step 608, to keep available tee times, which are searched by users, as updated as possible, the tee time compiling application is configured to trigger a fetch of tee data at regular or scheduled time intervals. As stated above, this fetching may be performed by linking to tee sheet vendor APIs, by coupling tee time reservation computing server 106 to golf course computing servers 108A-108N and/or their respective databases 120A-120N, or by having golf courses provide tee data at regular or scheduled intervals. Alternatively, in lieu of updating tee data at regular or scheduled intervals, golf course computing servers 108A-108N can be configured to send new tee data whenever there is a change in one of their tee times, green fees, and number of golfers scheduled for those tee times.

At Step 610, based on the city's name or the zip code provided by the user, the user (golfer) location determining application is configured to link to a third party map API that can adjust to the golfer's provided geographical location. In one embodiment, a plurality of geographical maps associated with golf courses, which have an established partnership to provide their tee data, may be stored in tee time database 118. As such, upon receipt of data indicative of the geographical location of the user, the golf course mapping application 512 is configured to retrieve a corresponding geographical map for display for the user. Alternatively, instead of receiving the location data from the user, his/her geographical location may be determined by a geo-locator, such as global positioning system (GPS) application.

At Step 612, golf course mapping application 512 is configured to show the location of the golf courses on the displayed map via location indicators, e.g., a map flag, based on a golfer location tracking. As Step 614, golf course mapping application 512 is further configured to determine open/available tee times based on compiled tee times, associated with the golf courses located within the area displayed on the geographical map, and display location indicators that are suitable to the entered tee times and hold the open tee times. Alternatively, golf course mapping application 512 may be configured to display all of the location indicators, and display them with different colors and/or shapes. Such that, the location indicators that hold open tee times are displayed with one particular color and/or a particular shape, whereas the location indicators that do not hold open tee times are displayed with a different color and/or a different shape. This visually distinguishable display of the tee times enables the user to save time in a selection process of a golf course and the tee time reservation.

As Step 616, as stated above, a golfer search for suitable tee times can take place using a displayed search criteria box or window. The search criteria may include a zip code, a city's name, a tee time or tee time slot, and a number of golfers that may want to play together. Alternatively, at Step 618, the user may click on or touch a screen location of a search button to trigger a search for all available tee times, which will be displayed in a table below a displayed geographical map associated with a location of the user, and for golf courses located within the map view. The time slot may be any of a riser time slot, a mid day time slot, and an afternoon time slot. These time slots enable the user to see ample tee time openings in a wider time swatch to meet his/her needs.

Following a display of the location indicators on the geographical map, at Step 620, the user may click on or touch an area of the touch screen of a location indicator of a desired golf course. Subsequently, a pop-up window is displayed to show the user golf course details and tee time data, which includes categories such as tee times, number of scheduled golfers, green fees, and a reservation button. Moreover, the pop-up window may include information about distances separating the user location, the entered zip code, or the entered city's name, and the listed golf courses. In one embodiment, the distance info, which lists the number of miles separating the user's current location, according to geo-location completed by the user when coming onto the Web site, and the golf course may be put into the pop-up widow between the name of the corresponding golf course and the header. Alternatively, the determined distance info may be part of the pop-up window as a separate category. Moreover, the display of the categories may be programmed so that the user may be able to sort in an ascending or descending manner any of them.

After clicking on the reservation button, a reservation completion Web page is displayed. Upon completion of the reservation process, at Step 622, the golf course is notified and the user is notified via an email or a text message.

A golf course typically schedules players by assigning each group of players/golfers (typically between one and four players) a tee time at which they will begin their game. Typically, tee times are scheduled for the first hole of a nine-hole golf course, and are scheduled for the first hole or the tenth hole of an eighteen-hole course. Each tee time assigned to a group is often spaced from other tee times by at least seven to ten minute intervals, so that individual golfers or groups of golfers are scheduled to tee off (i.e. to start their games) at specific time intervals. Each game is expected to end a certain time after it starts, and this “average game time” is typically estimated according to the golf course operator's experience.

In one exemplary embodiment, a golf course that has and manages its own Web site may be able to send the available tee times directly to tee time database 118 or to a database integral to tee time reservation computing server 106. A golf course that doesn't have its own Web site can send tee time openings via email and/or facsimile to be loaded into tee time database 118, and provided to the user via the Web after compiling and determining all open tee times. Moreover, a golf course, without the convenience of a Web site, an e-mail device, and a fax device, can provide tee times by calling an agent, associated with the tee time scheduling entity that is responsible for and in charge of operating for the present disclosure, which can load them into tee time database 118 manually.

In one exemplary embodiment, tee time reservation computing server 106 utilizes the latest and most secure web applications to ensure that all transactions are protected and safe from external security violations.

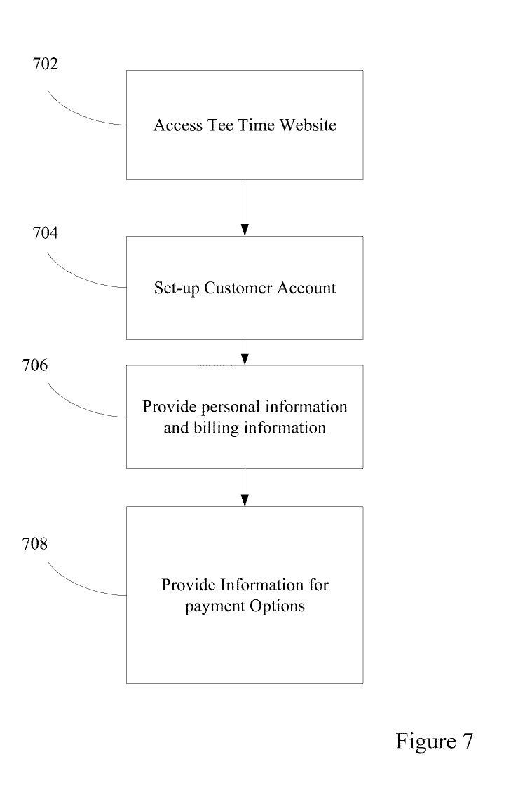

Now referring to FIG. 7, a flow chart 700 illustrates a process or method for establishing a user/customer account with the tee time scheduling entity. The customer needs to establish an account with the tee time scheduling entity in order to reserve tee times at desirable golf courses. The customer account is opened or set up as follows. The customer accesses the scheduling entity's Web site using the Internet and a computer running a Web browser program, at Step 702. The computer may be a wireless mobile personal computer 102, personal computer 104, or any other computer with access to the Internet. After connecting to the scheduling entity's Web site, the customer can begin the account set-up by following procedures provided on related Web pages of the Web site, at step 704. Typically, in setting up an account the customer is requested to provide personal information, billing information, credit card information, and a password. The personal information can include a first name, a last name, an email address, and a phone number. The billing information can include a mailing address, which in turn includes a street address, a city's name, a zip code, and a state's name. After entering personal identifying and billing information, at Step 706, the customer is further requested to enter payment options information, which can include electronic payments (epayment), at Step 708. The epayment option can be at least one of a credit card number representing a chargeable credit card account associated with the customer, or a debit card number representing a debitable bank account associated with the customer. Additionally, the customer can be requested to enter a user login name to expedite future logins to the scheduling entity's home Web page. Based on the provided customer information, customer identification is generated by a corresponding customer information application 514 running on computing server computer 106 for storage in the scheduling entity database 118.

In accordance with the present disclosure, the number of golf courses, determined to have available tee times and displayed on a geographical map, is based on their respective distance to the area of the entered zip code, to the entered city, or to a residential address of the golfer. In one embodiment, a maximum distance that the user has to travel to reach a selected golf course can be preset. As such, the number of displayed of golf courses may be less than the total number of golf courses that were found to have available tee times that match the entered tee times, because the non-displayed golf courses are located beyond the preset maximum distance to the user geo-location. In one embodiment, the preset maximum distance may be provided by the user as a search criteria parameter.

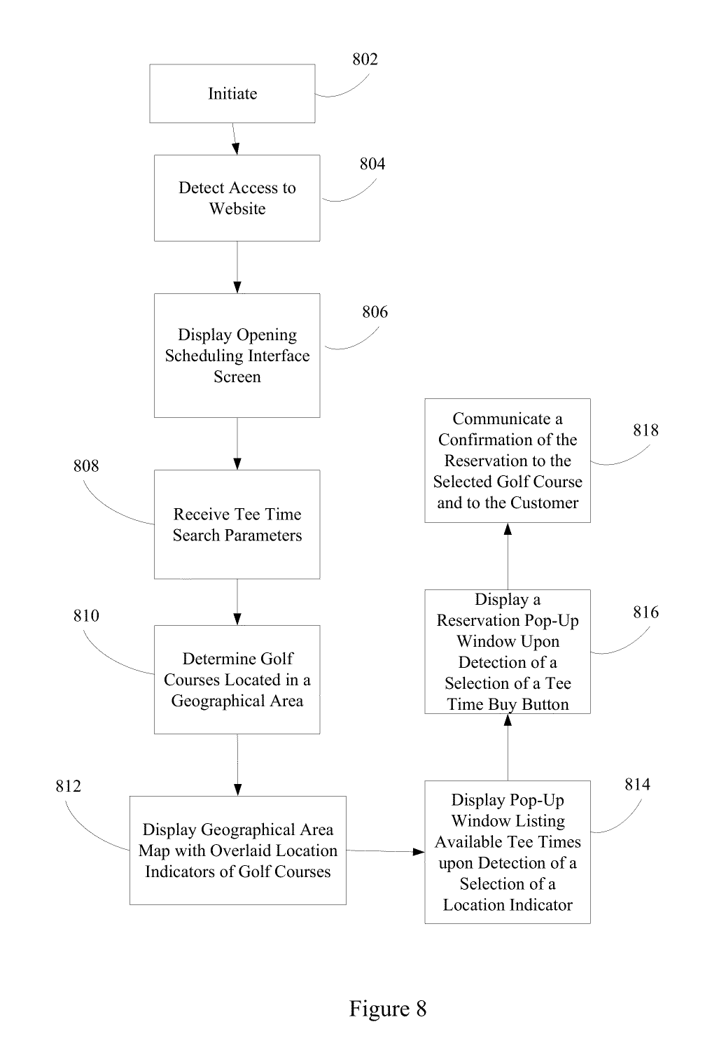

Now referring to FIG. 8, a flow chart shows an exemplary embodiment of a method 800, initiated at Step 802, for enabling a user to search online for available tee times suitable for his/her schedule and budget and making a tee time reservation. In one embodiment, the customer accesses the scheduling entity's Web site using the Internet and a computing device running a Web browser program, at Step 804. After connecting to the scheduling entity's Web site, the customer can begin the tee time scheduling by following procedures provided on related Web pages of the Web site.

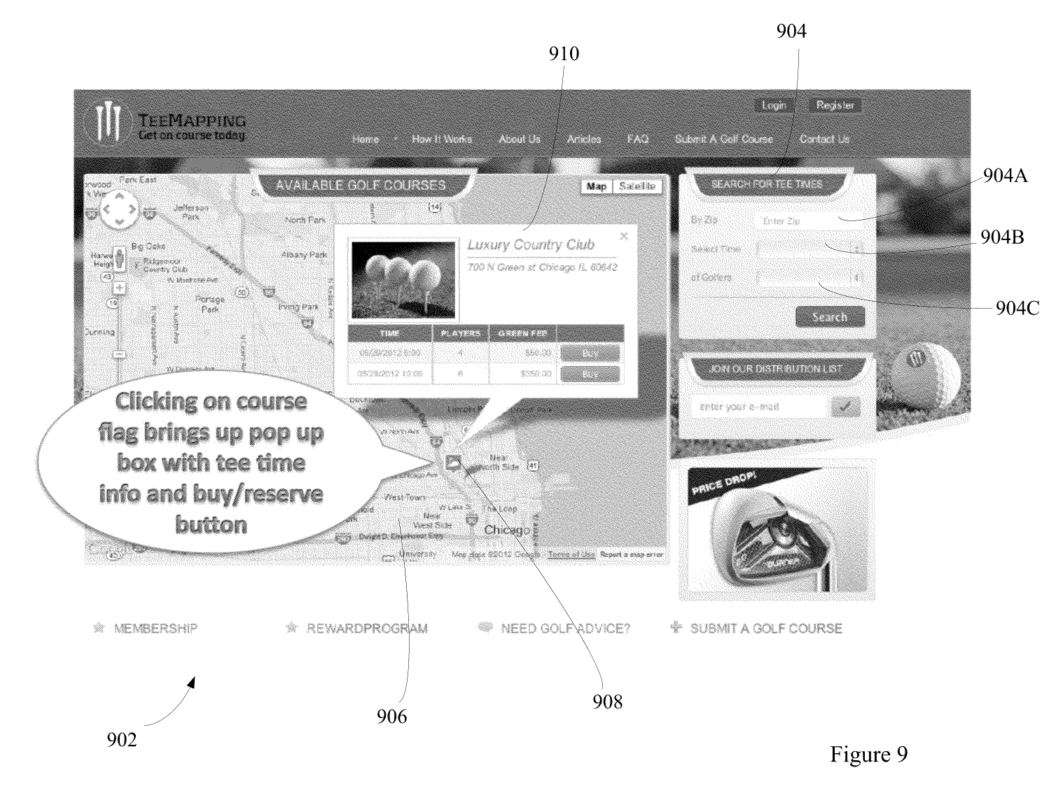

In one embodiment, the tee time scheduling application 516 can be configured to generate and display an opening scheduling interface screen 902 shown in FIG. 9, at Step 806, which allows the customer to begin the search for desirable tee times at golf courses located within a select geographical area. In one embodiment, the opening scheduling interface screen 902 is part of the scheduling entity Web homepage. As shown, the opening scheduling interface screen 902 can be configured to display a “Search for Tee Times” window 904 that includes three parameter entry boxes. In a “By Zip” parameter box 904A, the customer can enter a zip code of where or near where he/she would like to play golf. In a “Select Time” parameter box 904B, the customer can enter a desirable play time. In a “of Golfers” parameter box 904C, the customer can enter a number of golfers that would like to play together. Upon entry of these three parameters, at Step 808, tee time scheduling application 516 is configured to determine suitable golf courses, located in a geographical area that includes the area associated with the entered zip code, which have available tee times that match the entered desirable play time and the entered number of golfers, at Step 810. Tee time scheduling application 516 is then configured to display an interactive geographical map 906 with overlaid location indicators 908, such as map flags for example, to mark the location of the determined area golf courses, at Step 812. At Step 814, upon detection of a simple hover or mouse click on one of the location indicators 908, tee time scheduling application 516 is configured to generate and display a pop-up window 910 that lists available tee times, associated with the selected golf course, which match the entered tee time or that start after the entered tee time. For each listed available tee time, a number of players/golfers, a green fee, and a Buy toggle/button (i.e., make a reservation) are also listed in the pop-up window 910. Upon detection of a selection of the Buy button, tee time scheduling application 516 is configured to generate and display a reservation pop-up window 910, at Step 816. Subsequently, upon completion of the reservation process, tee time scheduling application 516 is configured to communicate a confirmation of the reservation to the selected golf course and to the user, at Step 818.

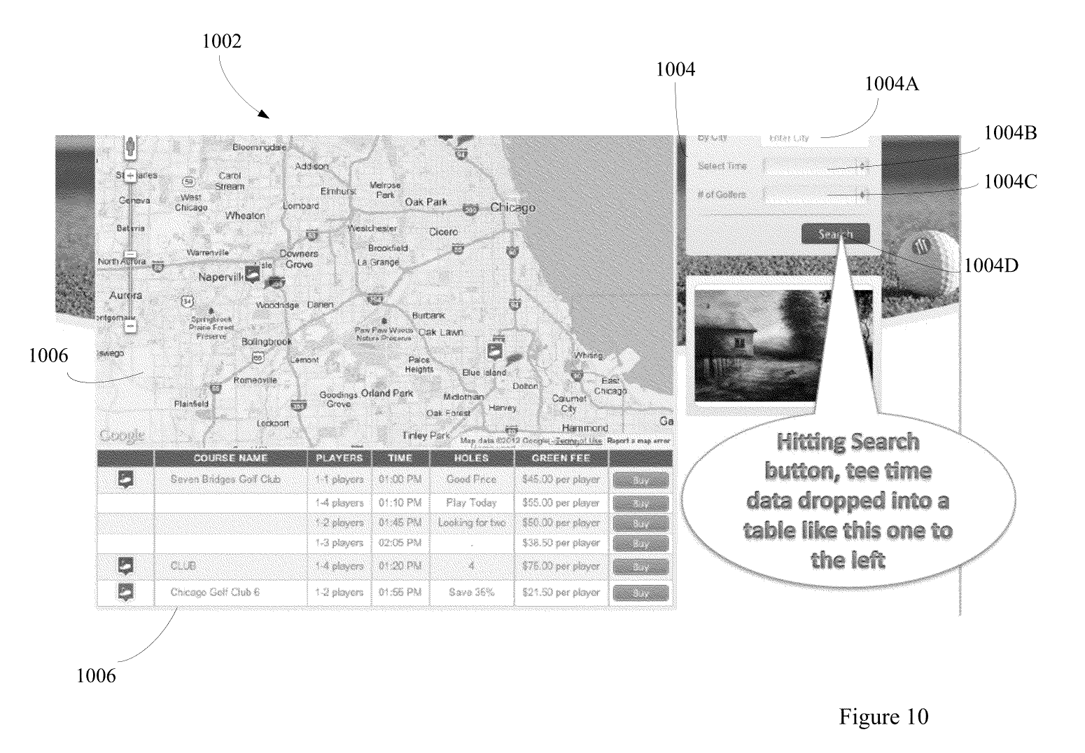

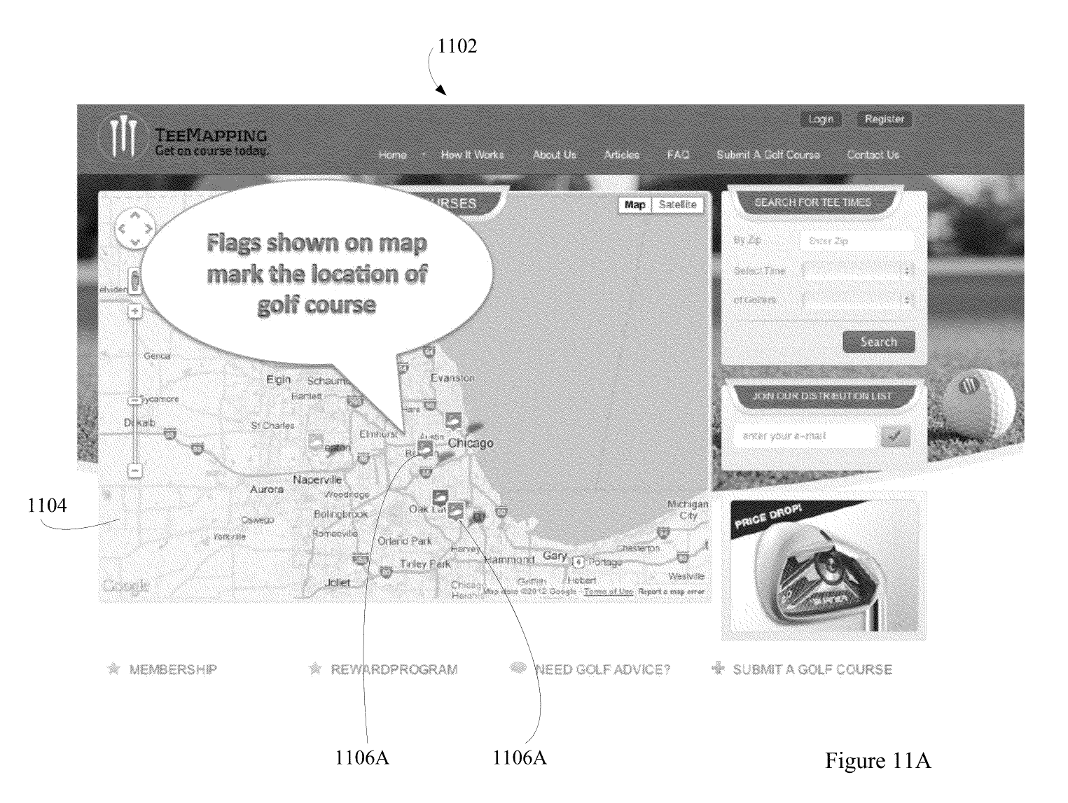

Now referring to FIG. 10, in one embodiment in addition to configuring and displaying the geographical map, tee time scheduling application 516 is also configured to generate and display a table, below geographical map 906 for example, which includes the determined available tee times and associated golf courses. As shown in FIG. 10, the displayed user interface screen 1002 includes “Search for Tee Times” window 1004, which in turn includes a “By City” parameter box 1004A, where the customer can enter a city's name, instead of a zip code, where or near where he/she would like to play golf. Moreover, “Search for Tee Times” window 1004 includes a “Select Time” box 1004B, a “of Golfers” parameter box 904C, and a “Search” button/toggle 904D.

Once the user clicks on the Search button 904D, tee time scheduling application 516 is configured to generate and display a geographical map 1008 having overlaid thereon location indicators 1008A of determined golf courses, and a table 1010. As shown, table 1006 lists golf courses using their respective names, the available tee times, the number of players who can play at each available tee time, the holes, i.e., 9 and/or 18 holes, available for each available tee time, the green fee per player to pay for each available tee time, and an option to buy each available tee time. Once the user clicks on one of the boxes listing the option to buy one of the available tee times, tee time scheduling application 516 is configured to generate and display a reservation window.

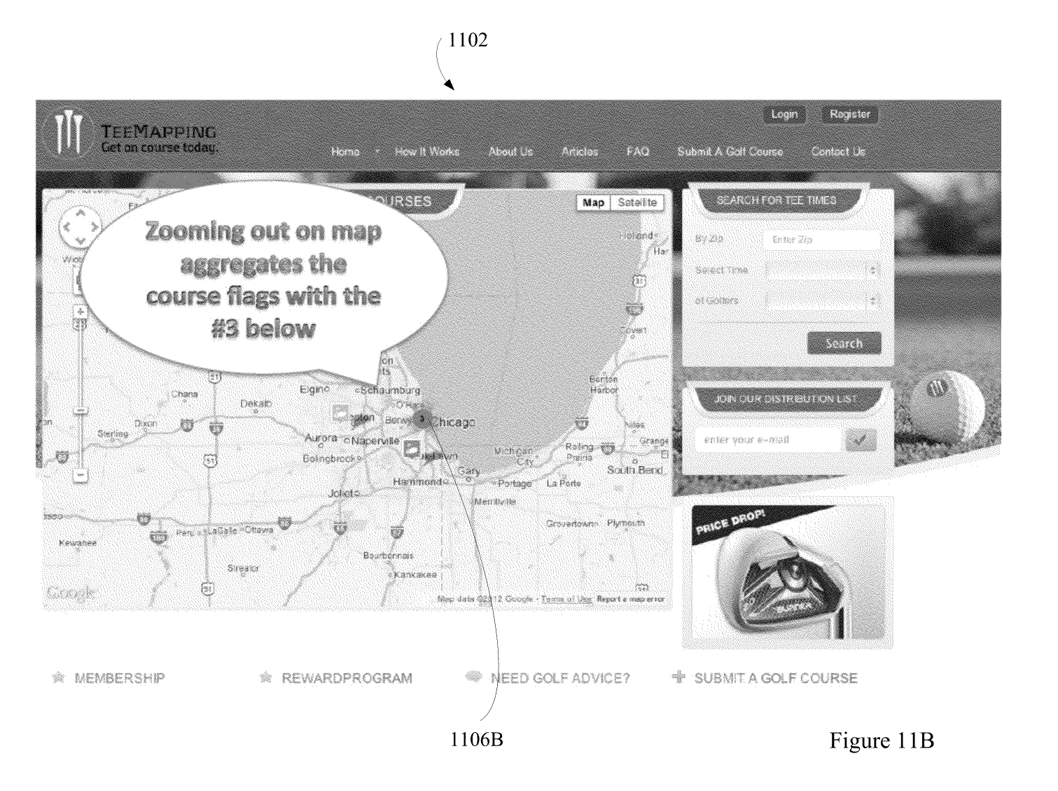

Now referring to FIG. 11A, a displayed user interface screen 1102 includes a geographical map 1104 having overlaid thereon location indicators 1106A that represent the geographical location of their corresponding golf courses. Upon detection of a user's request to zoom out on the displayed geographical map, tee time scheduling application 516 is configured to aggregate the location indicators 1106A into one or more new location indicators 1106B, as shown in FIG. 11B. In one embodiment, the new displayed location indicators 1106B may visually include a numerical reference indicative of the number of the location indicators 1106A that were aggregated.

As shown in FIGS. 11A and 11B, user interface screen 1102 may include a “Join Our Distribution List” window 1108 in which the user may enter an email address so that the tee time scheduling entity may keep him/her posted about potential future available tee times that match tee times reserved as results of his/her previous tee time search attempts. In another embodiment, the tee time scheduling entity may keep the user, who provided his/her email address, posted about potential green fee deals.

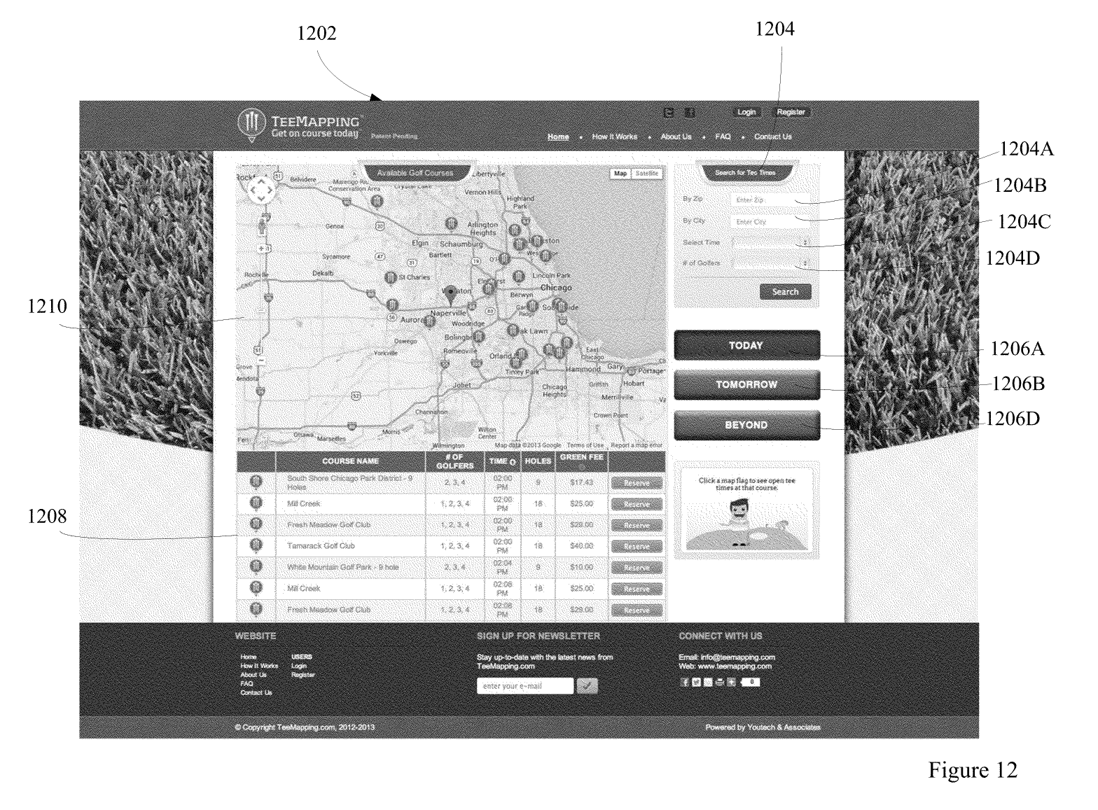

In another embodiment, the tee time scheduling application 516 can be configured to generate and display another opening scheduling interface screen 1202 of FIG. 12, which allows the customer to begin the scheduling of desirable tee times at a golf course located within a select geographical area. As shown, the opening customer ordering interface screen 1202 can be configured to display a “Search for Tee Times” window 1204 that includes a “By Zip” parameter box 1204A, a “By City” parameter box 1204B, a “Select Time” parameter box 1204C, a “of Golfers” parameter box 1204D. Moreover, opening customer ordering interface screen 1202 displays a “Today” toggle switch 1206A, a “Tomorrow” toggle switch 1206B, and a “Beyond” toggle switch 1206C. In one embodiment, “Today” toggle 1206A is programmed as the default golf playing day. When the user selects the “Tomorrow” toggle or the “Beyond” toggle, tee time scheduling application 516 is configured to adjust all of the tee times within the displayed location indicators as well as tee time data listed in table 1208 that is displayed below the geographical map 1210. In one embodiment, if the entered city mane is matched in more than one state, tee time scheduling application 516 is configured to provide a list of the states for selection of a proper state by the user. Moreover, the user need not enter both a zip code and a city name; because tee time scheduling application 516 is configured to adjust the displayed geographical map based the data entry of only one of them.

In one embodiment, if the user has plans to seek tee times to play at a location that is quite distant from where he/she resides and/or to play on a day that is beyond today or tomorrow, tee time scheduling application 516 is configured to trigger weather forecast retrieving application 520 to access a weather Web site and retrieve a weather forecast for the user's selected play day. Upon retrieval of the forecasted weather, tee time scheduling application 516 is configured to display it so that the user may decide whether to modify his/her entered tee times if they seem to lead to a determination of available tee times that are weatherly non-conducive for an enjoyable golf outing.

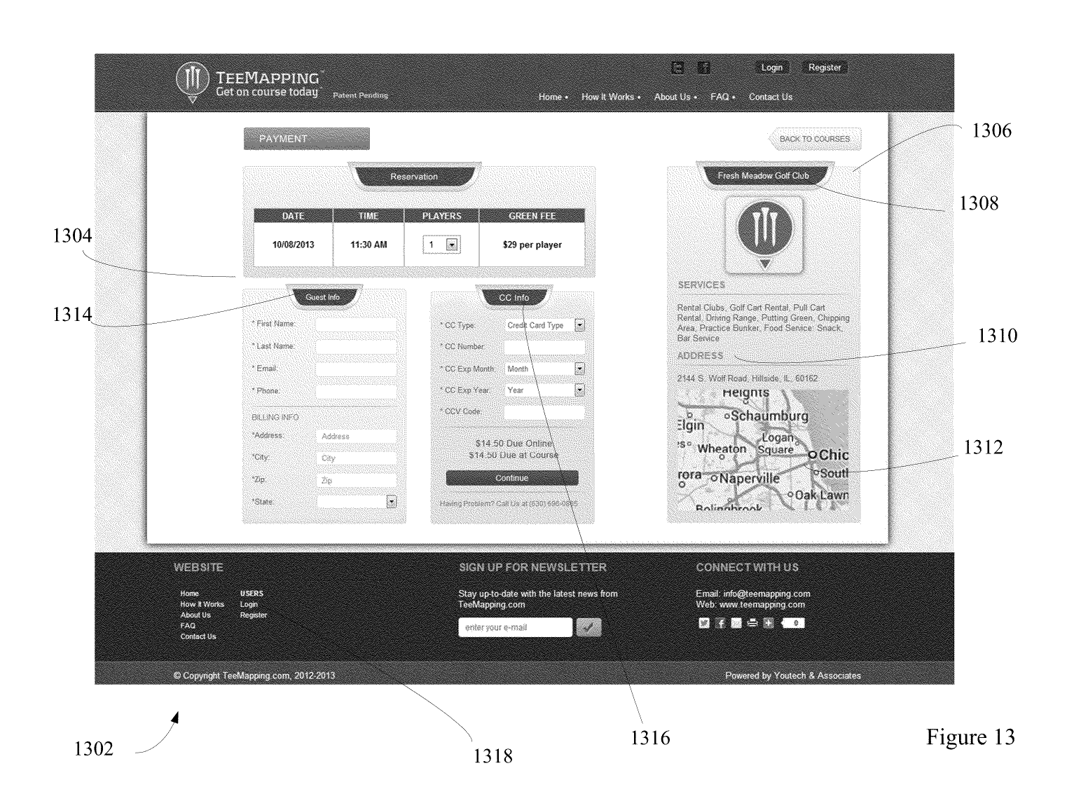

Now referring to FIG. 13, an exemplary embodiment of a one-page confirmation interface screen 1302 is shown. Tee time scheduling application 516 is configured to make the tee time reservation process as easy and quick as possible by generating and displaying the one-page confirmation interface screen 1302. As shown, the one-page confirmation interface screen 1300 includes a table 1304 that was generated after the user has selected a specific tee time from amongst the displayed available tee times that were determined based on the user's tee time search criteria entered in the above-discussed opening scheduling interface screens. The one-page confirmation interface screen 1302 further includes a window 1306 that lists a golf course name 1308, the address of the golf course 1310, and a geographical map 1312 that shows a location of the golf course.

The tee time data, listed in table 1304, includes a tee date, a tee time, a number of players, a green fee, and can also include a number of holes (not shown) to be played.

Still referring to FIG. 13, to help complete the reservation, table 1304 also includes a guess info box 1314 and a credit card (CC) info box 1316. The guess information box can include eights parameter entry boxes. The first listed four parameter entry boxes, which relate to personal contact information, include a first name box, a last name box, an email address box, and a phone number box. The second listed four parameter boxes, which form billing information, include an address box, a city's name box, a zip code box, and a state's name box. The CC info box 1316 includes a CC type box, a CC number box, a CC expiration month box, a CC expiration year box, and a CC verification code box.

As shown below the CC information box 1316, the user can be offered alternate payment methods. In one embodiment, a payment of the total of charges of green fees may be due online or at the golf course. In another embodiment, a first portion of the total of charges of green fees may be due online and a second portion of the total of charges of green fees may be due at the golf course.

In one embodiment, if the user has already established a user ID with the tee time scheduling entity, then he/she could skip the entering of the guest information and CC information by simply hovering or mouse clicking on a user login toggle 1318.

In addition to having an established user ID, the user may also acquire a golf pass or gift card from the tee time scheduling entity. In one embodiment, the golf pass is generated by a gift card application 524 based on particular user information. The golf pass can be a pre-paid pass that will enable the user to buy a card from the tee time scheduling entity for a set fee. The user may then be able to make a reservation for a tee time through the tee time scheduling entity at any partnered golf course regardless of green fee prices. This golf pass can be sold by the tee time scheduling entity at a set rate for a particular number of rounds of golf. In one embodiment, the golf pass may be sold in 2, 4, 8, 12 round lots. Moreover, future use of the golf pass may be for 25, 50, and 100 round lots, for example. In addition, the golf pass may have an expiration date, which occurs after a set period from the purchase date. For example, the set period may be equal to twelve months.

In one embodiment, the tee time scheduling entity may partner with companies and organizations where their customers or employees could benefit from offerings from the tee time scheduling entity. Affiliated marketing partners may receive via emails content to send to their database of customers announcing the offering from the tee time scheduling entity. Within that communication, each affiliated partner may receive a unique promo code that will be assigned to one of their customers who signs into the tee time scheduling entity and that will be part of the confirmation process. Accordingly, any time a customer of the affiliated partner reserves a tee time through the tee time scheduling entity, the affiliated partner may receive a monetary donation per reservation. The affiliate partner may receive a monthly statement detailing the last name of the customer/golfer that made the reservation, the tee time date, the name of the golf course, and the number of golfers in the reservation along with the amount earned for that reservation. Along with the monthly statement, the affiliate partner will receive a check cut each month for the referral. Moreover, the golfer that becomes a customer of the tee time scheduling entity though an affiliate partner will be assigned to the affiliate as part of his/her user ID.

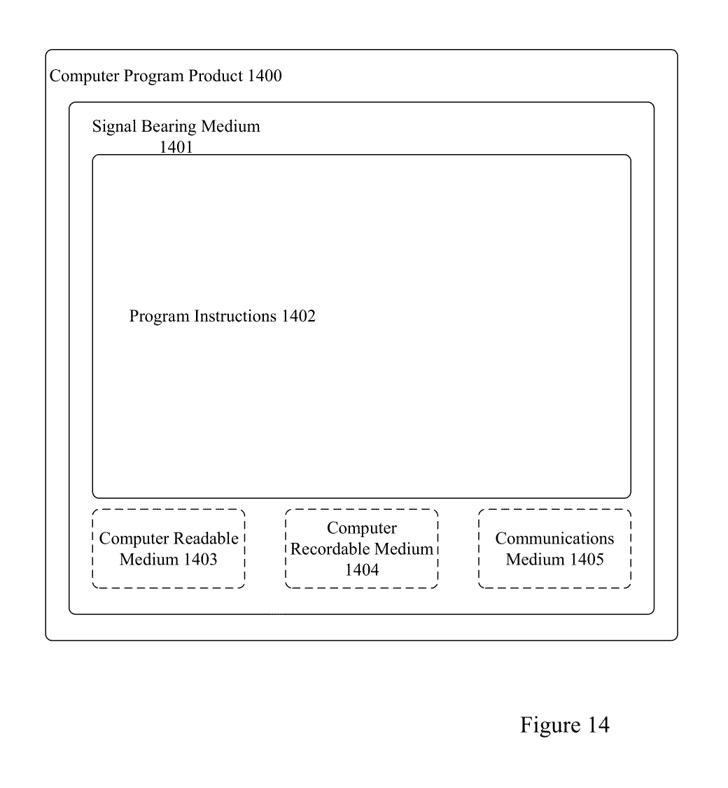

In some embodiments, the disclosed methods, as well as alternate methods, may be implemented as computer program instructions encoded on a computer-readable storage media in a machine-readable format. FIG. 14 is a schematic illustrating a conceptual partial view of an example computer program product 1400 that includes a computer program for executing a computer process on a computing device, arranged according to at least some embodiments presented herein. In one embodiment, the example computer program product 1400 is provided using a signal bearing medium 1401. The signal bearing medium 1401 may include one or more programming instructions 1402 that, when executed by a processing unit may provide functionality or portions of the functionality described above with respect to FIGS. 1-13.

In some examples/implementations, signal bearing medium 1401 may encompass a non-transitory computer-readable medium 1403, a computer recordable medium 1404, and a communications medium 1405.

The technical effects and technical problems discussed in the specification are exemplary and are not limiting. It should be noted that the embodiments described in the specification may have other technical effects and can solve other technical problems.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

What is claimed is:

1. A tee time scheduling system comprising:
a computing server including a processor and a memory that:
receives information from one or more computing servers, each of which is associated with a golf course, regarding a current and future tee time status of each one of the golf courses;
receives a query from a computing device regarding tee time openings occurring on a select day and in a particular geographical area;
determines tee time availability and associated golf courses located in the particular geographical area based on a comparison between the current and future tee time status and the select day;
generates a geographical map having overlaid thereon location indicators of the associated golf courses, and
forwards to the computing device for display on a display screen of the computing device the geographical map.

2. The tee time scheduling system of claim 1, wherein the query includes search criteria that can include a tee time or a time slot, a zip code or a name of a city.

3. The tee time scheduling system of claim 1, wherein the location indicators may be map flags or push pins.

4. The tee time scheduling system of claim 1, wherein the computing server further:
detects a selection of one of the location indicators; and
displays a pop-up window that includes a tee time table listing tee time data associated with the selected location indicator.

5. The tee time scheduling system of claim 4, wherein the tee time data includes a variety of categories that include a name of a golf course that corresponds to the selected indicator, available tee times at the named golf course, a number of golfers already scheduled to play at each of the available tee times, and a green fee to pay for each of the available tee times.

6. The tee time scheduling system of claim 5, wherein the tee time data further includes a number of holes available to play at each of the available tee times, and a buy button for each of the available tee times in order to make a reservation.

7. The tee time scheduling system of claim 6, wherein the computer server further:
detects a selection of one of the buy buttons; and
generates for display on the computing device an additional pop-up window that includes a reservation table for entering billing information and payment options.

8. The tee time scheduling system of claim 1, wherein in addition to the geographical map, the computer server further:
generates a golf course table that lists the associated golf courses and their respective tee time data.

9. A non-transitory computer-readable storage medium comprising programming instructions that are executable by a computing system to:
receive information from one or more computing servers, each of which is associated with a golf course, regarding a current and future tee time status of each one of the golf courses;
receive a query from a computing device regarding tee time openings occurring on a select day and in a particular geographical area;
determine tee time availability and associated golf courses located in the particular geographical area based on a comparison between the current and future tee time status and the select day;
generate a geographical map having overlaid thereon location indicators of the associated golf courses, and a golf course table that lists the associated golf courses and their respective tee time data; and
forward to the computing device for display on a display screen of the computing device the geographical map and the golf course table.

10. The non-transitory computer-readable storage medium of claim 9, wherein the query includes search criteria that can include a tee time or a time slot, a zip code or a name of a city.

11. The non-transitory computer-readable storage medium of claim 9, wherein the location indicators may be map flags or push pins.

12. The non-transitory computer-readable storage medium of claim 9, wherein the golf course table include a variety of categories that include names of the associated golf courses, their available tee times, a number of golfers already scheduled to play at each of their available tee times, and a green fee to pay for each of their available tee times.

13. A computer-implemented method for scheduling a tee time, comprising:
accessing a Web site of a tee time scheduling entity;
receiving a user interface screen that includes a window for entering a desirable tee time, and a geographical location;
receiving a geographical map with location indicators of golf courses overlaid thereon, wherein the golf courses were determined based on the entered tee time and the geographical location;
selecting one of the location indicators; and
receiving a pop-up window that includes a tee time table listing tee time data of a golf course associated with the selected location indicator.

14. The computer-implemented method for scheduling a tee time of claim 13, wherein the tee time data includes a variety of categories that include a name of the golf course, available tee times at the named golf course, a number of golfers already scheduled to play at each of the available tee times, and a green fee to pay for each of the available tee times.

15. The computer-implemented method for scheduling a tee time of claim 14, wherein the tee time data further includes a number of holes available to play at each of the available tee times, and a buy button for each of the available tee times in order to make a reservation.

16. The computer-implemented method for scheduling a tee time of claim 15, further comprising:
selecting one of the buy buttons; and
receiving an additional pop-up window that includes a reservation table for entering billing information and payment options.

17. The computer-implemented method for scheduling a tee time of claim 13, further comprising:
receiving in addition to the geographical map a golf course table that lists the associated golf courses and their respective tee time data.

18. The computer-implemented method for scheduling a tee time of claim 13, wherein the entered desirable tee time and a geographical location are part of search criteria, and wherein the geographical location is provided by entering a zip code and/or a city's name.

19. The computer-implemented method for scheduling a tee time of claim 13, wherein the location indicators may be map flags or push pins.

20. The computer-implemented method for scheduling a tee time of claim 13, wherein the entered the tee time include a Today date, a Tomorrow date, or a beyond today and tomorrow date.
